(19) United States
(12) Patent Application Publication
(10) Pub. No.: US 2004/0071516 A1
(43) Pub. Date: Apr. 15, 2004

(54) Drilling tool

(76) Inventor: Werner Hakenjos, Villingen-Schwenningen (DE)

Correspondence Address: M. Robert Kestenbaum, 11011 Bermuda Dunes NE, Albuquerque, NM, 87111, US

(21) Appl. No.: 10/614,381

(22) Filed: Jul. 6, 2003

(30) Foreign Application Priority Data
Jul. 18, 2002 (DE) 202 10 909.7

(51) Int. Cl. B23B 51/02

(52) U.S. Cl. 408/225

(57) ABSTRACT

In order to achieve especially low wear of the drilling tool during drilling and permit drilling with a high feed rate, the invention provides a drilling tool (1) having a shank (3) with a first end (5) and a second end (7), at least one of the ends having a drill head (8, 81, 82) with flutes (10), the drill head having at least three lips (9) and a centering cone (11), and the main cutting edges (91) of the at least three lips of the drill head (8, 81, 82) being relief-ground at least in sections, and the centering cone (11) projecting from an area which is described by the cutting edges (91) by rotation of the drilling tool about its shank axis (2).

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The invention relates to a drilling tool, in particular a drilling tool having at least three lips.

### TECHNICAL FIELD

Depending on their intended purpose, drilling tools are designed as two-lipped twist drills or also as crowning cutters. With the tools known from the prior art, the neat machining of metal sheets, in particular of body sheets on vehicles, is difficult if two-lipped tools are used. The latter tend to cant in the workpiece to a considerable extent, which may lead to damage and chipping. The tools also become blunt relatively quickly and have to be replaced or reground. The high loading of the lips also leads to pronounced heating of the cutting edges. Accordingly, the service life of the tool is reduced.

Here, the canting of the drilling tool, due to the mechanical loading, can quickly lead to distortion of the sheets, and this distortion can only be corrected with difficulty or not at all.

### SUMMARY OF THE INVENTION

The object of the invention is to provide a drilling tool that is suitable for the machining of sheets.

This object is already achieved in a most surprisingly simple manner by a drilling tool that includes a shank with a first end and a second end, at least one of the ends having a drill head with flutes, the drill head having at least three lips and a centering cone, and the main cutting edges of the at least three lips of the drill head being relief-ground at least in one portion, wherein the centering cone projects from an area which is described by the cutting edges by rotation of the drilling tool about a shank axis of the shank.

Advantageous developments according to the invention include a shank with a first end and a second end, at least one of the ends having a drill head with flutes, the drill head having at least three lips and a centering cone, and the main cutting edges of the at least three lips of the drill head being relief-ground at least in portions. In this case, the centering cone projects from an area that is described by the cutting edges by rotation of the drilling tool about its shank axis.

The drilling tool according to the invention is distinguished by the fact that, inter alia, three or more lips tend to cant to a considerably less extent than two-lipped tools. This results in a markedly smoother drilling behavior.

Likewise, the mechanical loading of the individual lip in the case of two or more lips is reduced compared with a two-lipped tool. Thus the wear can be reduced and the service life increased. Accordingly, the tool also does not have to be exchanged so frequently. The smaller tendency to lateral canting not only reduces the wear but also the likelihood of fracture of the tool. Due to the fact that the cutting is distributed over at least three lips, the chip cross section is also reduced. This also generally leads to comparatively smoother holes.

The centering cone projecting from the end cutting edges reduces deviation from the perpendicular during drilling. In addition, center punching before drilling is not necessary in order to produce a dead accurate hole.

The positive relief of the main cutting edges reduces the friction. This likewise leads to reduced wear of the tool. Accompanied by the reduced friction, the generation of heat at the cutting edges and thus their thermal loading are also reduced with the cutting capacity remaining the same. The torque required for the rotation of the drilling tool is also reduced, resulting in a lower drive output for the drilling. Due to the lower friction, additional cooling with environmentally polluting cooling liquids does not become necessary. The tool is thus suitable for dry machining.

A marked increase in production overall can thus be achieved with the tool according to the invention.

The tool is also especially suitable for releasing and drilling out welded, brazed or riveted connecting elements on sheets, such as, in particular, on body sheets of vehicles.

The tool can be used for drilling and releasing in the most varied materials, such as metals, plastics or composite materials, such as, for example, glass-fiber-reinforced plastics. Accordingly, the tool can be expediently used in all workshops and production plants.

According to a preferred embodiment, the area which is described by the main cutting edges by rotation of the drilling tool about its shank axis comprises essentially a plane area. Thus the end face of a hole drilled with the drilling tool also has a corresponding essentially plane area. This is especially favorable in order to drill out welded, brazed or riveted connecting elements and to thus release the connected parts. If two sheets are joined together in this way, it is possible in this way for the connection to be drilled out without drilling through the sheet on the rear side in the feed direction. Only the projecting centering cone penetrates into the second sheet in the process.

The feed pressure required for the drilling can especially be reduced by the centering cone likewise having at least three cutting edges. In particular, the cutting edges of the centering cone, in this case, may run obliquely relative to the feed direction. In particular, the cutting edges of the centering cone may have a smaller point angle than the main cutting edges. Thus, for example, the cutting edges may run about the rotation axis on a conical area. If the angle of the cutting edges relative to the shank axis, or the rotation axis, is greater than the angle of the main cutting edge axes relative to the rotation axis, the contact pressure of the cutting edges of the centering cone, during the feed of the drill, is higher than the contact pressure on the main cutting edges. In this way, the poorer cutting action due to the low circumferential velocity in the drill region close to the axis, in which the cutting edges of the centering cone are arranged, is partly compensated for.

The cutting edges of the centering cone may also be relief-ground in a positive manner at least in sections in order to reduce the friction and increase the cutting capacity.

In addition, the flanks of the secondary cutting edges may advantageously be relief-ground in order to reduce the friction of the drilling tool at the wall of the hole.

According to an embodiment of the invention, the shank has at least one step in the feed direction. Shank sections having different diameters are defined by the step, so that the shank section having the larger diameter can serve as a stop in order to set defined drilling depths.

The shank may have at least one clamping surface. The clamping surface can serve to prevent twisting of the drill in a suitable chuck.

In an advantageous manner, the drilling tool, in particular the drill head, may also have a functional coating. The coating may comprise, for example, a friction-reducing material, in particular a solid lubricant. This reduces the friction during the drilling and facilitates the chip disposal in the chip passages, thus making it more difficult for the chips to become wedged in the walls of the chip passages. The coating may also comprise an anti-corrosion material, which suppresses the corrosion of the tool, in particular at the cutting edges, and thus helps to prolong the service life. An especially favorable effect on the service life is obtained if the coating comprises a mechanically resistant material that protects the cutting edges. In addition, this permits drilling in hard material with a low rate of wear.

The material of the tool is advantageously as hard as possible. Suitable materials are, inter alia, carbide, fine-grain solid carbide, HSS or HSSE.

The flanks of the main cutting edges may have a convexly shaped region or, in particular, may also be completely convexly shaped. This shape permits lateral tilting of the tool during drilling up to a certain angle, which in a preferred embodiment is about 10° to the normal of the surface of the workpiece without the drill canting. The convex shape results in lower loading of the outer cutting surfaces when working with the tool. This results in markedly lower tool wear.

If both ends of the shank have a drill head, the tool does not have to be exchanged immediately if one of the drill heads is worn. The tool can then be turned round and clamped again, so that work can be continued with the other drill head. The drill heads may also have different diameters. In this way, different hole diameters can be drilled with one drilling tool. This is advantageous, for example, for drilling out and releasing various connecting elements or for separating sheets having different thicknesses which are connected by connecting elements.

In addition, the drill heads may also differ in other dimensions and characteristic variables. Thus the drill heads may have different rake angles, clearance angles, point angles or centering cones with different dimensions. The drill heads can thus be optimized for drilling various materials, for instance sheets of different hardness.

### BRIEF DESCRIPTION OF THE DRAWINGS

The invention is explained in more detail below with the aid of preferred embodiments and with reference to the attached drawings, in which the same designations refer to identical or similar parts.

In the drawings:

FIG. 1 shows a side view of an embodiment of the drilling tool according to the invention,

FIG. 2A shows a plan view of the drill head,

FIG. 2B shows a plan view of the drill head according to a further embodiment,

FIG. 3 shows a side view of a further embodiment of the drilling tool according to the invention, and

FIG. 4 shows a side view of an embodiment of the drilling tool according to the invention having two drill heads.

### DETAILED DESCRIPTION OF THE INVENTION

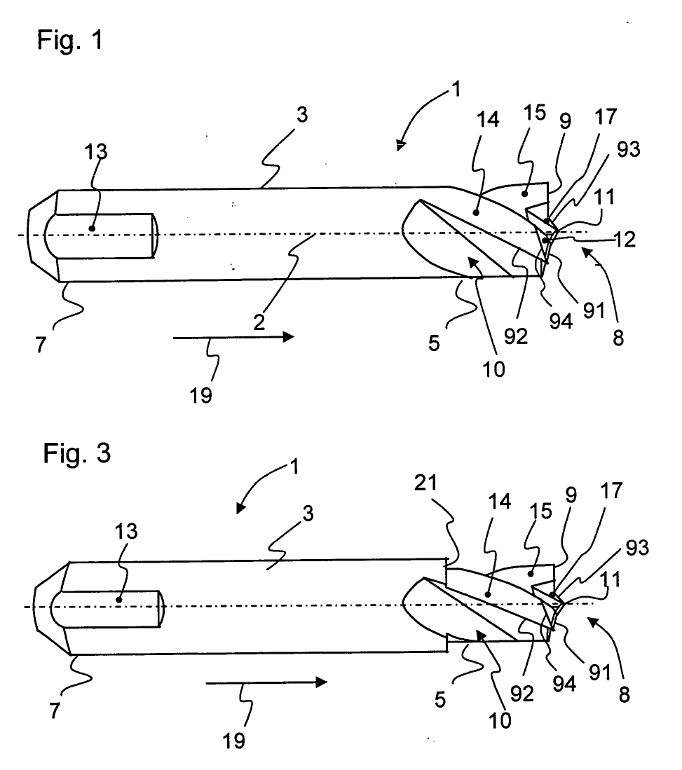

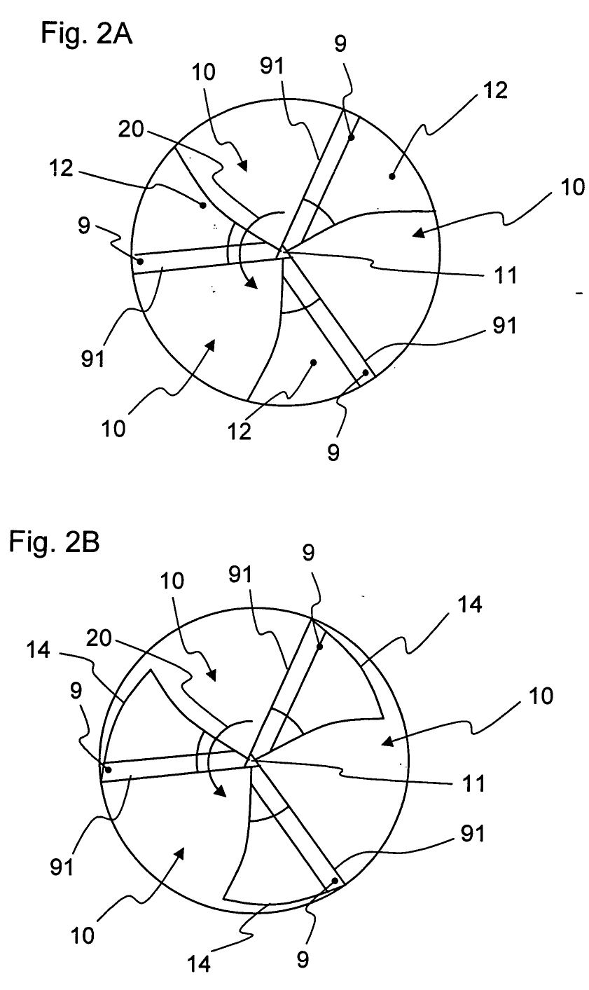

A side view of an embodiment of the drilling tool, designated as an entity by 1, is shown in FIG. 1. FIG. 2 shows a plan view of the end face of the drill head of the drilling tool 1. The drilling tool 1 comprises a shank 3 with a first end 5 and a second end 7. The first end 5 of the shank 3 has a drill head 8 with flutes 10. The second end 7 serves for locating in a suitable chuck. The drill head 8 has three lips 9 and a centering cone 11 on the end face of the shank 3. The flutes 10 run like a twist drill.

In addition, at its second end 7, the shank 3 has a clamping surface 13 which, by positive locking with a suitable drill chuck, prevents the twisting of the drilling tool.

The main cutting edges 91 of the three lips 9 of the drill head 8 are relief-ground. Accordingly, the flanks 12 of the main cutting edges 91 have a positive clearance angle.

The centering cone 11 is shaped in such a way that it projects from an area which is described by the cutting edges 91 by rotation of the drilling tool 1 about its shank axis or rotation axis 2. The projecting arrangement of the centering cone achieves the effect that an increased contact pressure compared with other areas of the end face of the drill head 8 acts on this centering cone during drilling. This results in centering of the drilling tool about the shank axis 2 running through the centering cone and thus prevents untrue running of the drilling tool 1.

The area that is described by rotation of the drilling tool 1 about its shank axis 2 comprises an essentially plane area in the embodiment described with reference to FIG. 1. Accordingly, the main cutting edges 91 of the tool 1 run in the radial direction essentially perpendicularly to the shank axis or rotation axis 2, and the point angle of the main cutting edges 91 is around 180°. Thus an essentially plane end face is produced by the main cutting edges 91 during drilling. This is especially advantageous for very small drilling depths, for instance if a connecting point between two metal sheets is to be drilled out and through-drilling of both sheets is not desired.

The centering cone 11 likewise has three cutting edges 93, which merge in the radial direction into the main cutting edges 91 of the tool 1. The cutting edges 93 of the centering cone 11 are also relief-ground in sections, so that their flanks have a positive clearance angle.

In addition, the cutting edge 93 run obliquely relative to the feed direction 19. In particular, in the embodiments described here, the cutting edges 93 run on the lateral surface of a cone, this lateral surface forming the envelope of the centering cone 11. In this case, the lateral surface of the cone is oriented in such a way that its tip points in the feed direction.

In addition, the obliquely running cutting edges 93 of the centering cone have a smaller point angle than the main cutting edges. The contact pressure on the cutting edges 93 of the centering cone is thus additionally increased relative to the main cutting edges during drilling. This ensures an adequate cutting action of the centering cone 11 or of the regions of the drill head 8 which are close to the axis.

In addition, the drilling tool is configured in such a way that the cutting edges 93 of the centering cone 11 have their own cutting surfaces 17. The cutting surfaces may be arranged in such a way that they have a rake angle which is approximately the same as that of the cutting surfaces 15 of the main cutting edges 91.

In addition, the flank 12 of the main cutting edges 91 may be shaped convexly. This permits drilling with an inclination of the drilling tool relative the surface of the workpiece. In this case, an inclination of up to 10° relative to the normal of the workpiece is possible without the drill running untrue or becoming chipped. The convex shape can also be achieved by grinding a plurality of surface segments which merge into one another and whose envelope is shaped convexly.

FIG. 2B shows a plan view of the drill head 8 of a further embodiment of the drilling tool 1. In contrast to the embodiment shown in FIG. 2A, the flanks 14 of the secondary cutting edges 92 are in this case also relief-ground. This additionally lowers the friction of the drilling tool in the drilling passage.

A view of yet another embodiment of the drilling tool is shown in FIG. 3. The shank has a step 21, so that the drill head 8 at the first end 5 has a smaller diameter than the second end 7 for locating in a drill chuck. The step serves as a stop during drilling, so that drill holes having a defined depth can be produced with this drilling tool.

The drilling tool 1 is preferably made of carbide, fine-grain solid carbide, HSS or HSSE in order to achieve sufficient hardness and elasticity of the drilling tool, in particular of the drill head 8.

In order to achieve a long service life even for drilling in hard materials, the tool may have a special coating.

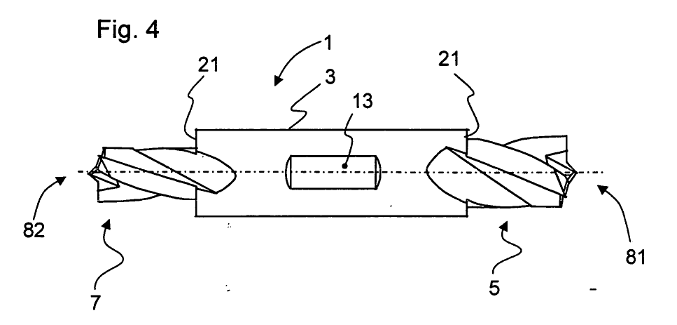

FIG. 4 shows a side view of an embodiment of the drilling tool 1 according to the invention which, in contrast to the embodiments described above, has a drill head 81 or 82, respectively, at each end 5 and 7 of the shank 3. Each of the drill heads 81 and 82 is shaped according to the invention.

The drill heads may have identical diameters or also, as shown in FIG. 4, different diameters. If the drill head diameters are identical, the drilling tool 1 need not be exchanged immediately after wear of one of the drill heads but rather can continue to be used with the other drill head. This additionally increases the service life of the drilling tool by a factor of two. In particular, an embodiment having two drill heads without steps in the shank is also possible.

Different diameters of the drill heads 81 and 82 can be used for different hole diameters, which likewise makes it unnecessary to change the tool if holes with two different hole diameters have to be drilled on a workpiece.

The drill heads may also differ with regard to their other parameters, such as centering-cone diameter and/or centering-cone height, point angle, clearance angle or rake angle, in order to adapt them to various workpiece materials.

In the embodiment shown in FIG. 4, the shank has a step 21 for each of the drill heads, at which the shank diameter increases in the feed direction for the respective drill head and which thus serves as a stop for limiting the drilling depth.

The drilling tool 1 shown in FIG. 4 has a clamping surface 13 in the center of the shank 3 between the two drill heads 81 and 82. However, the shank may likewise have two clamping surfaces 13 which are at a distance from one another in the axial direction or are opposite one another with respect to the shank axis 2.

It is obvious to the person skilled in the art that the invention is not restricted to the embodiments described. Thus the features of the various embodiments may also be combined with one another in many different ways. For example, the drilling tools shown in FIGS. 1 and 3 may have both a drill head according to FIG. 2A and a head as shown in FIG. 2B.

List of designations

| | |
|---|---|
| 1 | Drilling tool |
| 2 | Shank axis, rotation axis |
| 3 | Shank |
| 5 | First end of the shank 3 |
| 7 | Second end of the shank 3 |
| 8, 81, 82 | Drill head |
| 9 | Lips |
| 91 | Main cutting edges |
| 92 | Secondary cutting edges |
| 93 | Cutting edges of the centering cone |
| 94 | Side cutting edges |
| 10 | Flute |
| 11 | Centering cone |
| 12 | Flank of the main cutting edges 91 |
| 13 | Clamping surface |
| 14 | Flank of the secondary cutting edges 92 |
| 15 | Cutting surface |
| 17 | Cutting surface of the centering cone |
| 19 | Feed direction |
| 20 | Direction of rotation |
| 21 | Step |

I claim:

1. A drilling tool (1), comprising a shank (3) with a first end (5) and a second end (7), at least one of the ends having a drill head (8, 81, 82) with flutes (10), the drill head having at least three lips (9) and a centering cone (11), and the main cutting edges (91) of the at least three lips of the drill head (8, 81, 82) being relief-ground at least in sections, wherein the centering cone (11) projects from an area which is described by the cutting edges (91) by rotation of the drilling tool about its shank axis (2).

2. The drilling tool as claimed in claim 1, wherein the area which is described by the cutting edges (91) by rotation of the drilling tool about its shank axis (2) comprises essentially a plane area.

3. The drilling tool as claimed in claim 1, wherein the centering cone (11) has at least three cutting edges (93).

4. The drilling tool as claimed in claim 3, wherein the cutting edges (93) of the centering core (11) run obliquely relative to the feed direction of the tool, in particular wherein the cutting edges (93) of the centering cone (11) have a smaller point angle than the main cutting edges (91).

5. The drilling tool as claimed in claim 3, wherein the cutting edges (93) of the centering cone (11) are relief-ground in a positive manner at least in portions.

6. The drilling tool as claimed in claim 1, wherein the shank (3) has at least one step (21) in the feed direction (19) of the tool.

7. The drilling tool as claimed in claim 1, wherein the shank (3), preferably at the second end (7), has at least one clamping surface (13).

8. The drilling tool as claimed in claim 1, wherein the drilling tool, in particular the drill head (8, 81, 82), has a coating which comprises a mechanically resistant material.

9. The drilling tool as claimed in claim 8, wherein the coating comprises an anti-corrosion material.

10. The drilling tool as claimed in claim 1, wherein the material of the drill head (8, 81, 82) comprises at least one of carbide and fine-grain solid carbide and HSS and HSSE.

11. The drilling tool as claimed in claim 1, wherein the flanks (12) of the main cutting edges have a convexly shaped region, in particular wherein the flanks (12) of the main cutting edges are convexly shaped.

12. The drilling tool as claimed in claim 11, wherein the convexly shaped region is shaped in such a way that the drill works free of canting up to 10° to the normal of a workpiece surface to be spot-drilled.

13. The drilling tool as claimed in claim 1, wherein the flanks (14) of secondary cutting edges (92) of the tool are relief-ground.

14. The drilling tool as claimed in claim 1, wherein both ends (5, 7) of the shank (3) have a drill head (81, 82).

15. The drilling tool as claimed in claim 14, wherein the drill heads (81, 82) have different diameters.

16. The drilling tool as claimed in claim 14, wherein the drill heads (81, 82) have at least one of different rake angles and point angles and clearance angles and centering cones with different dimensions.
